(19) United States
(12) Patent Application Publication
(10) Pub. No.: US 2020/0402062 A1
(43) Pub. Date: Dec. 24, 2020

(54) DATA PROCESSING METHOD, APPARATUS AND COMPUTER-READABLE NON-TRANSITORY STORAGE MEDIUM

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventors: Weihang SHI, Beijing (CN); Hua LI, Beijing (CN)

(73) Assignees: BEIJING JINGDONG SHANGKE INFORMATION TECHNOLOGY CO., LTD., Beijing (CN); BEIJING JINGDONG CENTURY TRADING CO., LTD., Beijing (CN)

(21) Appl. No.: 16/491,837

(22) PCT Filed: Jan. 4, 2018
(86) PCT No.: PCT/CN2018/071294

§ 371 Date: Sep. 6, 2019

(30) Foreign Application Priority Data
Mar. 9, 2017 (CN) 201710138199.8

(51) Int. Cl. G06Q 20/40; H04L 9/32; G06F 16/245; G06Q 20/38

(52) U.S. Cl. CPC G06Q 20/4016; H04L 9/3236; H04L 2209/38; G06Q 20/389; G06Q 20/3827; G06F 16/245

(57) ABSTRACT

A data processing method, a data processing apparatus and a computer-readable non-transitory storage medium, the method including receiving, from an authenticating user, an authentication request for a historical transaction and transaction information of the historical transaction; generating authentication information of the historical transaction according to the transaction information of the historical transaction; acquiring storage information of the historical transaction from a block chain; comparing the authentication information of the historical transaction with the storage information of the historical transaction, and determining whether the transaction information of the historical transaction is authentic according to the result of comparison.

### CROSS-REFERENCE TO RELATED APPLICATIONS

The present application is based on and claims priority to CN application No. 201710138199.8 filed on Mar. 9, 2017, the disclosed content of which is hereby incorporated in the present application as a whole.

### TECHNICAL FIELD

The present disclosure relates to the field of computer technologies, and in particular, to a data processing method, a data processing apparatus, and a computer-readable non-transitory storage medium.

### BACKGROUND

In the information society, the management and storage of information resources is an important premise for supporting various activities. Database technology is a storage technology which is widely used at present.

A centralized storage mode is applied for the database, which makes it extremely easy for content modification. The stored content can be modified as long as you have the management authority of the database. Currently, transaction information is generally stored in a database of a third party, and depends on the public trust of the third party. When a user needs to authenticate the transaction information, the user requests the third party and obtains the transaction information from a database of the third party.

### SUMMARY

According to some embodiments of the present disclosure, there is provided a data processing method comprising: receiving, from an authenticating user, an authentication request for a historical transaction and transaction information of the historical transaction; generating authentication information of the historical transaction according to the transaction information of the historical transaction; acquiring storage information of the historical transaction from a block chain; comparing the authentication information of the historical transaction with the storage information of the historical transaction, and determining whether the transaction information of the historical transaction is authentic according to the result of comparison.

In some embodiment, the acquiring storage information of the history transaction from the block chain comprises: acquiring a storage address of the storage information of the historical transaction in the block chain according to the transaction information of the historical transaction; acquiring the storage information of the historical transaction according to the storage address of the storage information of the historical transaction in the block chain.

In some embodiments, the data processing method further comprises: generating storage information of a transaction according to transaction information of the transaction; submitting the storage information of the transaction to a block chain cluster; receiving a storage address in the block chain of the storage information of the transaction returned by a node in the block chain cluster; associating the transaction information of the transaction with the storage address of the storage information of the transaction in the block chain and storing a relationship between the transaction information of the transaction and the storage address of the storage information of the transaction in the block chain.

In some embodiments, the data processing method further comprises: querying a storage address of first contract information corresponding to the data information in the block chain, in response to a request for purchasing a right to use data information sent by a purchaser; submitting purchase information of the purchaser to a node in a block chain cluster according to the storage address of the first contract information, so that the node in the block chain cluster determines whether the purchaser has a purchasing authority or not according to the purchase information and the first contract information, wherein the first contract information comprises a preset threshold of the number of purchases of the data information or a preset identity attribute of a purchaser; receiving an execution result of the first contract sent by the node in the block chain cluster for indicating whether the purchaser has the purchasing authority or not; returning a result of purchasing the right to use the data information to the purchaser according to the execution result of the first contract of the data information.

In some embodiments, the data processing method further comprises: generating storage information of the data information, in response to a request for selling data information from a seller; respectively submitting to a block chain cluster, the storage information of the data information to be transacted and the contract parameters corresponding to the data information to be transacted; receiving, from a node in the block chain cluster, a storage address in the block chain of the storage information of the data information to be transacted and a storage address in the block chain of contract information generated according to the contract parameters.

In some embodiments, the data processing method further comprises: receiving, from a source user, data information to be transacted and contract parameters corresponding to the data information to be transacted; generating storage information of the data information to be transacted according to the data information to be transacted; respectively submitting to a block chain cluster, the storage information of the data information to be transacted and the contract parameters corresponding to the data information to be transacted; receiving, from a node in the block chain cluster, a storage address in the block chain of the storage information of the data information to be transacted and a storage address in the block chain of contract information generated according to the contract parameters.

In some embodiments, the authentication information of the historical transaction is a hash value generated according to the transaction information of the historical transaction in the authentication request; the storage information of the historical transaction is a hash value generated according to a transaction information obtained when the payment of the historical transaction is successful; the transaction information of the historical transaction comprises: order information.

According to still other embodiments of the present disclosure, there is provided a data processing apparatus comprising: a processor; and a memory coupled to the processor and storing instructions that when executed by the processor, cause the processor to: receive, from an authenticating user, an authentication request for a historical transaction and transaction information of the historical transaction; generate authentication information of the historical transaction according to the transaction information of the historical transaction; acquire storage information of the historical transaction from a block chain; compare the authentication information of the historical transaction with the storage information of the historical transaction, and determine whether the transaction information of the historical transaction is authentic according to the result of comparison.

In some embodiments, acquiring storage information of the history transaction from the block chain comprises: acquiring a storage address of the storage information of the historical transaction in the block chain according to the transaction information of the historical transaction; acquiring the storage information of the historical transaction according to the storage address of the storage information of the historical transaction in the block chain.

In some embodiments, the memory further storing instructions which, when executed by a processor, cause the processor to: generate storage information of a transaction according to transaction information of the transaction; submit the storage information of the transaction to a block chain cluster; receive a storage address in the block chain of the storage information of the transaction returned by a node in the block chain cluster; associate the transaction information of the transaction with the storage address of the storage information of the transaction in the block chain and store a relationship between the transaction information of the transaction and the storage address of the storage information of the transaction in the block chain.

In some embodiments, the memory further storing instructions which, when executed by a processor, cause the processor to: query a storage address of first contract information corresponding to the data information in the block chain, in response to a request for purchasing a right to use data information sent by a purchaser; submit purchase information of the purchaser to a node in a block chain cluster according to the storage address of the first contract information, so that the node in the block chain cluster determines whether the purchaser has a purchasing authority or not according to the purchase information and the first contract information, wherein the first contract information comprises a preset threshold of the number of purchases of the data information or a preset identity attribute of a purchaser; receive an execution result of the first contract sent by the node in the block chain cluster for indicating whether the purchaser has the purchasing authority or not; return a result of purchasing the right to use the data information to the purchaser according to the execution result of the first contract of the data information.

In some embodiments, the memory further storing instructions which, when executed by a processor, cause the processor to: generate storage information of the data information, in response to a request for selling data information from a seller; submit information of the seller and the generated storage information of the data information to a block chain cluster so that a node in the block chain cluster determines whether the seller has a selling authority of the data information or not according to the information of the seller, the storage information of the data information and second contract information, wherein the second contract information comprises the storage information of the data information stored in the block chain and information of a user having the selling authority which corresponds to the storage information of the data information stored in the block chain; receive an execution result of the second contract returned by the node in the block chain cluster for indicating whether the seller has the selling authority or not; return a result of selling the data information to the seller according to the second contract execution result of the data information.

In some embodiments, the memory further storing instructions which, when executed by a processor, cause the processor to: receive, from a source user, data information to be transacted and contract parameters corresponding to the data information to be transacted; generate storage information of the data information to be transacted according to the data information to be transacted; respectively submit to a block chain cluster, the storage information of the data information to be transacted and the contract parameters corresponding to the data information to be transacted; receive, from a node in the block chain cluster, a storage address in the block chain of the storage information of the data information to be transacted and a storage address in the block chain of contract information generated according to the contract parameters.

In some embodiments, the authentication information of the historical transaction is a hash value generated according to the transaction information of the historical transaction in the authentication request; the storage information of the historical transaction is a hash value generated according to a transaction information obtained when the payment of the historical transaction is successful; the transaction information of the historical transaction comprises: order information.

According to further embodiments of the present disclosure, there is provided a computer-readable storage medium storing computer program instructions, when executed by a processor, cause the processor to receive, from an authenticating user, an authentication request for a historical transaction and transaction information of the historical transaction; generate authentication information of the historical transaction according to the transaction information of the historical transaction; acquire storage information of the historical transaction from a block chain; compare the authentication information of the historical transaction with the storage information of the historical transaction, and determine whether the transaction information of the historical transaction is authentic according to the result of comparison.

In some embodiments, acquiring storage information of the history transaction from the block chain comprises: acquiring a storage address of the storage information of the historical transaction in the block chain according to the transaction information of the historical transaction; acquiring the storage information of the historical transaction according to the storage address of the storage information of the historical transaction in the block chain.

In some embodiments, the computer-readable non-transitory storage medium further storing program instructions which, when executed by a processor, cause the processor to: generate storage information of a transaction according to transaction information of the transaction; submit the storage information of the transaction to a block chain cluster; receive a storage address in the block chain of the storage information of the transaction returned by a node in the block chain cluster; associate the transaction information of the transaction with the storage address of the storage information of the transaction in the block chain and store a relationship between the transaction information of the transaction and the storage address of the storage information of the transaction in the block chain.

In some embodiments, the computer-readable non-transitory storage medium further storing program instructions which, when executed by a processor, cause the processor to: query a storage address of first contract information corresponding to the data information in the block chain, in response to a request for purchasing a right to use data information sent by a purchaser; submit purchase information of the purchaser to a node in a block chain cluster according to the storage address of the first contract information, so that the node in the block chain cluster determines whether the purchaser has a purchasing authority or not according to the purchase information and the first contract information, wherein the first contract information comprises a preset threshold of the number of purchases of the data information or a preset identity attribute of a purchaser; receive an execution result of the first contract sent by the node in the block chain cluster for indicating whether the purchaser has the purchasing authority or not; return a result of purchasing the right to use the data information to the purchaser according to the execution result of the first contract of the data information.

In some embodiments, the computer-readable non-transitory storage medium further storing program instructions which, when executed by a processor, cause the processor to: generate storage information of the data information, in response to a request for selling data information from a seller; submit information of the seller and the generated storage information of the data information to a block chain cluster so that a node in the block chain cluster determines whether the seller has a selling authority of the data information or not according to the information of the seller, the storage information of the data information and second contract information, wherein the second contract information comprises the storage information of the data information stored in the block chain and information of a user having the selling authority which corresponds to the storage information of the data information stored in the block chain; receive an execution result of the second contract returned by the node in the block chain cluster for indicating whether the seller has the selling authority or not; return a result of selling the data information to the seller according to the second contract execution result of the data information.

In some embodiments, the computer-readable non-transitory storage medium further storing program instructions which, when executed by a processor, cause the processor to: receive, from a source user, data information to be transacted and contract parameters corresponding to the data information to be transacted; generate storage information of the data information to be transacted according to the data information to be transacted; respectively submit to a block chain cluster, the storage information of the data information to be transacted and the contract parameters corresponding to the data information to be transacted; receive, from a node in the block chain cluster, a storage address in the block chain of the storage information of the data information to be transacted and a storage address in the block chain of contract information generated according to the contract parameters.

Other features and advantages thereof of the present disclosure will become apparent from the following detailed description of exemplary embodiments thereof with reference to the accompanying drawings.

### BRIEF DESCRIPTION OF THE DRAWINGS

To explain the embodiments of the present invention or the technical solutions in the prior art more clearly, a brief introduction will be given below for the drawings required in the description of the embodiments or the prior art. Apparently, the drawings illustrated as follows are merely some of the embodiments of the present disclosure. An ordinary person skilled in the art may also acquire other drawings according to such drawings without paying any inventive effort.

FIG. 1 illustrates a schematic flow diagram of a data processing method according to some embodiments of the present disclosure.

FIG. 2 illustrates a schematic flow diagram of a data processing method according to further embodiments of the present disclosure.

FIG. 3 illustrates a schematic flow diagram of a data processing method according to further embodiments of the present disclosure.

FIG. 4 illustrates a schematic block diagram of a data processing apparatus according to some embodiments of the present disclosure.

FIG. 5 illustrates a schematic block diagram of a data processing apparatus according to further embodiments of the present disclosure.

FIG. 6 illustrates a schematic block diagram of a data processing apparatus according to further embodiments of the present disclosure.

### DETAILED DESCRIPTION

The technical solutions in the embodiments of the present disclosure will be clearly and completely described below with reference to the drawings of the embodiments of the present invention. Obviously, the described embodiments are just a part, instead of all, of the embodiments of the present invention. The following description of at least one of the schematic embodiments is actually merely illustrative, and is not meant to be limitation on the present disclosure and its application or use in any way. All other embodiments obtained by persons of ordinary skill in the art based on the embodiments of the present disclosure without paying creative efforts shall fall within the protection scope of the present disclosure.

The inventors realized that database technology has great limitations. Firstly, due to the centralized storage mode of database application, there is a risk of data tampering or even loss once the database is paralyzed or attacked. Secondly, the stored content can be tampered with as long as the management authority of the database is possessed, so that there is a risk of internal staff tampering with the data. The storage mode of the database has the potential of insecurity in general. Because the storage mode of the database has risks and the transaction information cannot be stored safely and is easy to be tampered with, the user cannot accurately and truly authenticate the transaction information in the future.

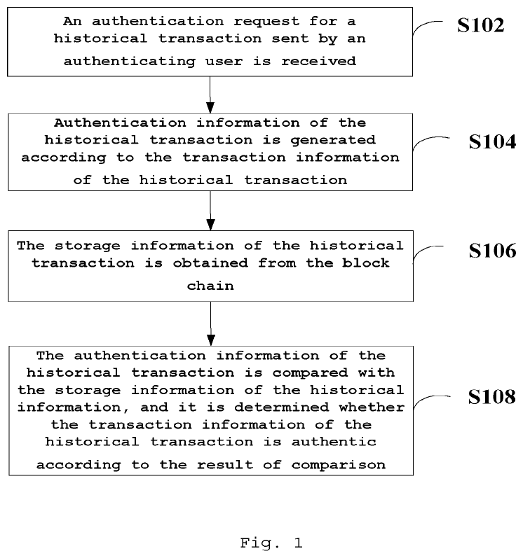

The data processing method of the present disclosure is described below with reference to FIG. 1.

FIG. 1 is a flow diagram of some embodiments of a data processing method of the present disclosure. As shown in FIG. 1, the method of the embodiment comprises: steps S102 to S108.

In step S102, an authentication request for a historical transaction sent by an authenticating user is received.

The authentication request comprises transaction information of the historical transaction. The transaction information may specifically comprise order information (comprising, for example, information of an object of the transaction, information of a buyer and a seller, time information, transaction amount information, and the like). The transaction information may further comprise an identification of data information for the transaction, that is, information uniquely identifying the object of the transaction, or an identification of a transaction platform. The transaction information may further comprise a private key of the transaction. The private key of the transaction is a secret key generated according to the transaction information of the historical transaction, and is used for further improving the safety of the transaction information and reducing the possibility of the transaction information being tampered with. The object of the historical transaction may be data information or a normal commodity or the like.

Since the block chain has full network availability, a user can issue an authorization request to any node in the block chain cluster. In practice, a source tracing platform can be developed to dock any node in the block chain cluster. The user can submit an authentication request to the source tracing platform, and meanwhile the transaction information of the historical transaction stored by the user, and the transaction information stored in the transaction platform for performing the historical transaction can also be called according to the authentication request of the user (the authentication request comprises part of the transaction information such as an order number, a transaction number, etc.).

The source tracing platform and the transaction platform of the historical transaction can be the same platform. When they are not the same platform, a user can submit the identification of the transaction platform to the source tracing platform to obtain transaction information stored in the transaction platform of the historical transaction through an interface between the two platforms. For example, the user logs in the source tracing platform to perform authentication, inputs an order number or a transaction number and sends a request for authentication. If the source tracing platform inquires that the transaction information of the historical transaction does not exist in the local storage, the source tracing platform prompts the user to input the name or the identification of the transaction platform and the certification information of the transaction platform. The source tracing platform sends a request to acquire the transaction information to the transaction platform through the interface, and the transaction platform returns the transaction information of the historical transaction to the source tracing platform after authenticating the user. And the transaction platform binds and stores the user's information and the transaction information. The authenticating user may be either party of the transaction.

In step S104, authentication information of the historical transaction is generated according to the transaction information of the historical transaction.

The authentication information of the historical transaction is, for example, a hash value generated according to the transaction information of the historical transaction in the authentication request. The hash value can uniquely identify the transaction information, and the generated hash value is different once the transaction information is tampered with. The step can be completed by the source tracing platform or the transaction platform of the historical transaction. Namely, when the source tracing platform requests for the transaction information from the transaction platform of the historical transaction, the transaction platform directly returns the hash value of the transaction information.

In step S106, the storage information of the historical transaction is obtained from the block chain.

Optionally, a storage address of the storage information of the historical transaction in the block chain is acquired according to the transaction information of the historical transaction; and the storage information of the historical transaction is acquired according to the storage address of the storage information of the historical transaction in the block chain. According to the transaction information submitted by the user, such as the order information, the identification of data information for the transaction and the like, the storage address of the storage information of the associated historical transaction in the block chain can be found. The storage address of the storage information of the historical transaction can be stored in the source tracing platform or the transaction platform of the historical transaction in association with the transaction information of the historical transaction, and can also be submitted by the user. The stored information of the historical transaction is, for example, a hash value generated according to a transaction information obtained when the payment of the historical transaction is successful.

In step S108, the authentication information of the historical transaction is compared with the storage information of the historical information, and it is determined whether the transaction information of the historical transaction is authentic according to the result of comparison.

In the case where the authentication information of the historical transaction is consistent with the storage information of the historical transaction, it is determined that the transaction information of the historical transaction is true.

According to the method of the above embodiment, the storage information of the historical transaction is stored in the block chain, and the storage information of the historical transaction cannot be tampered with and can be checked in the whole network based on the storage characteristics of the block chain. The transaction information of the historical transaction submitted by the authenticating user is generated into authentication information, and the storage information of the historical transaction can be obtained from any node of the whole network. The authentication information is compared with the storage information, so that whether the transaction information of the historical transaction submitted by the user is real and reliable can be verified. The security of the storage of the transaction information is improved while improving the accuracy and authenticity of the authentication. In addition, since the user does not need to perform authentication through a specific node, the user experience is improved.

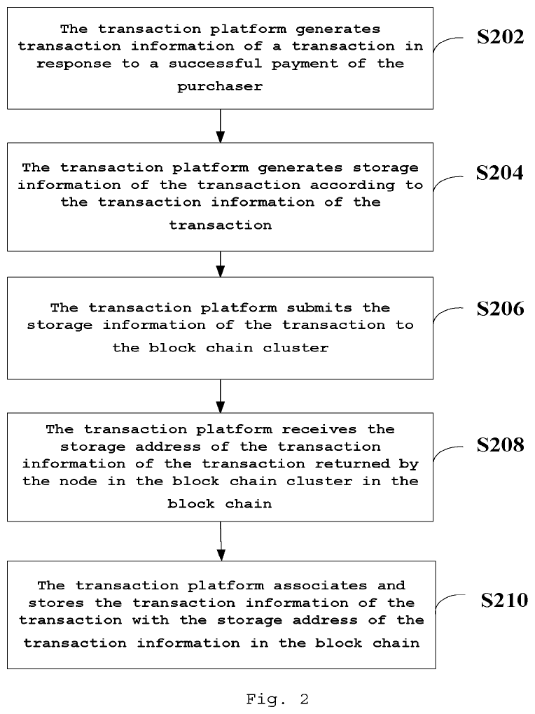

The present disclosure also provides a method of storing transaction information, which is described below with reference to FIG. 2.

FIG. 2 is a flow diagram of other embodiments of the data processing method of the present disclosure. As shown in FIG. 2, the method also comprises steps S202-S210 prior to step S102.

In step S202, the transaction platform generates transaction information of a transaction in response to a successful payment of the purchaser.

The purchaser and the authenticating user can be the same user or different users. The purchaser performs a payment to complete the transaction on the transaction platform, and the generated transaction information may also comprise order information, and may further comprise an identification of data information used for the transaction, a private key of the transaction, and an identification of the transaction platform. The transaction platform can save the transaction information for the user to authenticate in the future.

In Step S204, the transaction platform generates storage information of the transaction according to the transaction information of the transaction.

The storage information is, for example, a hash value generated based on the transaction information.

In Step S206, the transaction platform submits the storage information of the transaction to the block chain cluster.

The block chain is a storage technology. The block chain cluster comprising a plurality of block chain nodes, is a device cluster which can actually implement of the block chain technology. The transaction platform is docked with the block chain cluster, and can submit the storage information of the transaction to any node in the block chain cluster. Once the storage information of the transaction is submitted to the block chain, it will be confirmed by the miners, and the storage information of the transaction along with other transaction information will be packaged into a block and submitted to the block chain. The storage information of the transaction is confirmed by all miners once it is submitted to the block chain. The transaction will always exist in this block and cannot be deleted. At the same time, the block chain will timestamp the storage information of the transaction, and the authenticating user can confirm the time of the transaction according to the timestamp when performing authentication.

In Step S208, the transaction platform receives the storage address of the transaction information of the transaction returned by the node in the block chain cluster in the block chain.

After the storage information of the transaction is stored in the block chain, the node in the block chain cluster returns the storage address to the transaction platform.

In Step S210, the transaction platform associates and stores the transaction information of the transaction with the storage address of the transaction information in the block chain.

Some application examples of the above methods are described below. After a user A purchases and pays for the data S of a user B on the transaction platform, the transaction platform generates transaction information D1 of the data S, comprising order information (for example, information of the user A which is the buyer and the user B, a transaction time, transaction amount, information of the data S, etc.), an identification of the data S, an identification of the transaction platform, a private key of the transaction, and so on. The transaction platform locally stores the transaction information D1, generates a hash value H1 of the transaction information D1 and then submits it to the block chain for storage, and the node in the block chain cluster returns a storage address.

The transaction platform associates the storage address with the transaction information D1, stores the associated storage address in the order management system, and associates the associated storage address with the user A and the user B. After a period of time, if the user A or B or other authenticating users want to authenticate the transaction information of the data S, he/she will submit an authentication request in the transaction platform. The authentication request comprises the identification of the user A or the user B and the number of the order or the transaction. After the user is authenticated by the transaction system, the related transaction information D2 is called (the transaction information D2 is the same as the transaction information D1 if the transaction information D2 is not tampered with). After the transaction information D2 is confirmed by the authenticating user, the corresponding hash value H2 is generated by the transaction platform, and the transaction platform acquires the stored hash value H1 from the block chain cluster according to the storage address. The H1 is compared with the H2, and if the H1 and the H2 are consistent, the transaction information D2 is proved to be consistent with the D1, and the transaction information D2 is real.

The method of the embodiment realizes the storage of the transaction information in the block chain, and ensures the security of the transaction information.

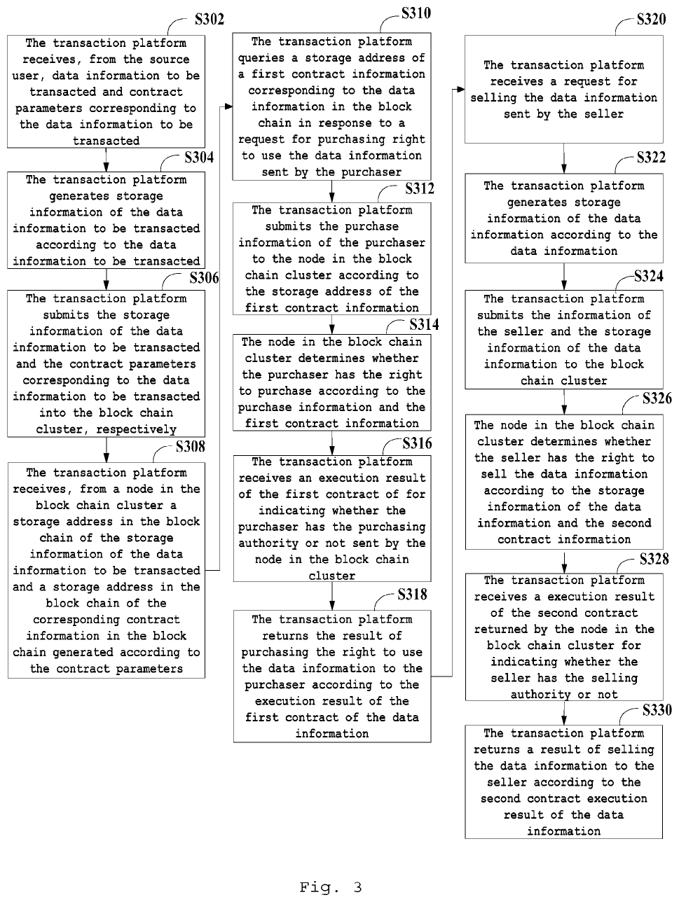

The user may also set a contract for the data information for sale in this disclosure, as described below with reference to FIG. 3.

FIG. 3 is a flow diagram of some embodiments of the data processing method of the present disclosure. As shown in FIG. 3, the method of this embodiment comprises: steps S302 to S330.

In step S302, the transaction platform receives, from the source user, data information to be transacted and contract parameters corresponding to the data information to be transacted.

The source user can set any restriction information for the data information to be transacted on the transaction platform as the contract information. The source user only needs to upload the contract parameters, such as the number of transactions, at least one identity attribute of at least one purchaser, and the like, in contract information on the transaction platform during the setting. The source user may set an upper limit on the number of transactions, e.g., 100, if the source user does not wish to transact data information, e.g., a song, too many times. Alternatively, the source user may simply wish to sell the song to a user using a particular carrier cell phone number, and may set the identity attribute of the user that can purchase the song as using the particular carrier cell phone number, etc.

In Step S304, the transaction platform generates storage information of the data information to be transacted according to the data information to be transacted.

In Step S306, the transaction platform submits the storage information of the data information to be transacted and the contract parameters corresponding to the data information to be transacted into the block chain cluster, respectively.

In Step S308, the transaction platform receives, from a node in the block chain cluster a storage address in the block chain of the storage information of the data information to be transacted and a storage address in the block chain of the corresponding contract information in the block chain generated according to the contract parameters.

The data information to be transacted and the corresponding contract information can be stored in different blocks. When a user purchases the data information to be transacted, the contract content can be directly executed in the corresponding block according to the storage address of the contract information.

A method of restricting a user who would purchase data information according to contract information is further described below with reference to FIG. 3.

In step S310, the transaction platform queries a storage address of a first contract information corresponding to the data information in the block chain in response to a request for purchasing the right to use the data information sent by the purchaser.

After receiving a request for purchasing the right to use the data information sent by the purchaser, the transaction platform inquires whether the owner of the data information, namely the source user, has set a contract or not, and if the contract has been set, the storage address of the contract information is inquired.

In step S312, the transaction platform submits the purchase information of the purchaser to the node in the block chain cluster according to the storage address of the first contract information.

The purchase information of the purchaser may be set according to the rule of the contract. For example, if only the number transactions is limited in the contract, the block chain only needs to be informed that one user has purchased this data information; if the contract specifies that the purchaser's information needs to be recorded, the purchaser's identification or the like has to be sent to the block chain cluster.

In step S314, the node in the block chain cluster determines whether the purchaser has the right to purchase according to the purchase information and the first contract information.

The first contract information comprises, for example, a preset threshold of the number of purchases of the data information. The number of purchases is decreased by 1 each time the purchase information of a user is received in the block chain. It is determined that the purchaser has no purchasing right when the remaining number of purchases is 0. And the purchaser can also be recorded so as to trace the source of the trader of the data information conveniently in the future. The first contract information comprises, for example, least one identity attribute of at least one purchaser, and the block chain compares the identity attribute of the purchaser sent by the transaction platform with the identity attribute of the purchaser in the contract information, and if the identity attribute of the purchaser sent by the transaction platform is consistent with one of the at least one identity attribute of the at least one purchaser specified by the contract, the purchaser is determined not to have the right to purchase.

In Step S316, the transaction platform receives an execution result of the first contract for indicating whether the purchaser has the purchasing authority or not sent by the node in the block chain cluster.

In Step S318, the transaction platform returns the result of purchasing the right to use the data information to the purchaser according to the execution result of the first contract of the data information.

The method of the above embodiment realizes the control of the data transaction by the seller of the data transaction, which satisfies the requirements of different sellers, and realizes accurate control of the distribution and the downloading of the data, and avoids trading the data for many times, and thus improves user experience.

The user selling the data information may restrain the user purchasing the right to use the data information from selling the data information again, as further described below with reference to FIG. 3.

In step S320, the transaction platform receives a request for selling the data information sent by the seller.

The request for selling the data information comprises the data information.

In Step S322, the transaction platform generates storage information of the data information according to the data information.

In step S324, the transaction platform submits the information of the seller and the storage information of the data information to the block chain cluster.

The information of the seller is, for example, the identification of the seller, the identity information of the seller, and the like. The transaction platform may perform the steps in this embodiment according to a contract set by a user that has sold data at the transaction platform. For example, user A uploads data information and sets up a contract on the transaction platform. The contract comprises that other users are not allowed to sell the data information except for the legal owners of the data information. When the seller B uploads the data information, the data information uploaded by the seller B needs to be compared with the data information uploaded by the user A, and the seller B is matched with the list of the legal owners set by the user A.

In step S326, the node in the block chain cluster determines whether the seller has the right to sell the data information according to the storage information of the data information and the second contract information.

The second contract information may be stored in the block chain. The second contract information comprises the storage information of the data information stored in the block chain and information of at least one user having the selling authority which corresponds to the storage information of the data information stored in the block chain. The node in the block chain cluster compares the storage information of the data information sent by the transaction platform with the storage information of the data information stored in the block chain and, if they are consistent, compares information of the seller with the information of the at least one user having the selling authority corresponding to the data information. And if the seller is not in the range of the at least one user with the selling authority, the seller does not to have the right to sell the data information.

In step S328, the transaction platform receives an execution result of the second contract returned by the node in the block chain cluster for indicating whether the seller has the selling authority or not.

In step S330, the transaction platform returns a result of selling the data information to the seller according to the second contract execution result of the data information.

Further, if the seller has the right to sell the data information, the storage information corresponding to the data information of the seller is stored into the block chain, and the seller may also set contract information for the data information.

The method of the above embodiment realizes the protection of the ownership of the data information by the data information seller, and in particular, the seller enjoying the copyright of the data information and the like can prevent illegal users from selling piracy and infringement products, so that the legal rights and interests of the users are ensured, and the user experience is improved.

Further, in addition to selling the right to use the data information, the ownership of the data information may also be sold. When the source user uploads the data information to be transacted, corresponding third contract information can be set, and the contract information comprises the preset condition of a user that can obtain the ownership of the data information. The transaction platform transmits the information of a purchaser to the block chain cluster in response to the purchaser's request for purchasing the ownership of the data information, and the node in the block chain cluster determines whether the purchaser can purchase the ownership of the data information according to the third contract information.

Optionally, the node in the block chain cluster compares the information of the purchaser with the preset condition of the user that can obtain the ownership of the data information in a third contract, and if the information of the purchaser is consistent with the preset condition, the information of the purchaser is added to the owner list corresponding to the data information and stored in the block chain. And the transaction platform receives the result of purchase returned by the node in the block chain cluster and returns the purchasing result to the purchaser.

It should be noted that the method of the above embodiments, i.e., the embodiments of steps S102 to S108, the embodiments of steps S202 to S210, the embodiments of steps S302 to S308, the embodiments of steps S310 to S318, the embodiments of steps S320 to S330, and the embodiments for selling the ownership of data information, may be arbitrarily combined, or may be formed separately.

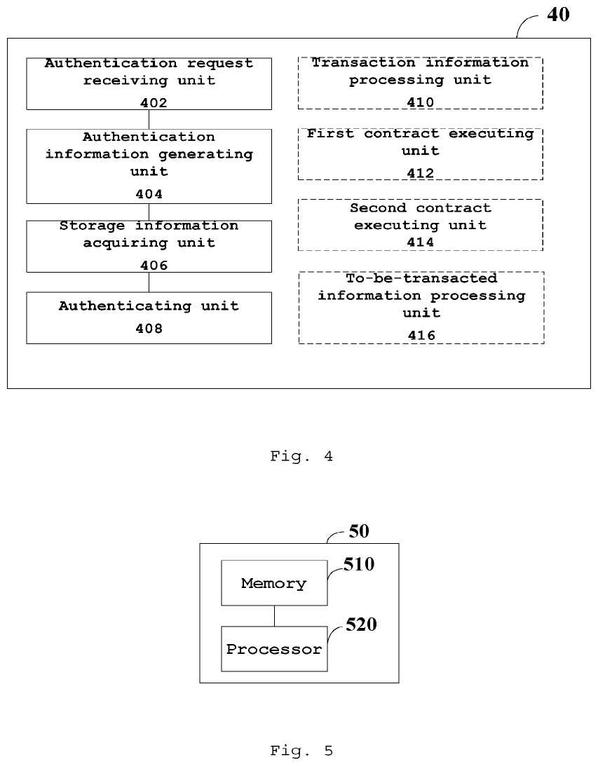

The present disclosure also provides a data processing apparatus, which will be described below with reference to FIG. 4.

FIG. 4 is a structural diagram of some embodiments of a data processing apparatus of the present disclosure. As shown in FIG. 4, the apparatus 40 comprises: an authentication request receiving unit 402, a authentication information generating unit 404, a storage information acquiring unit 406, and an authenticating unit 408.

The authentication request receiving unit 402 is configured to receive, from an authenticating user, an authentication request for a historical transaction and transaction information of the historical transaction. For example, the authentication request receiving unit 402 may perform step S102.

The authentication request comprises transaction information of the historical transaction. The transaction information may comprise the order information, and may further comprise an identification of data information for the transaction, a private key of the transaction, or an identification of the transaction platform.

The authentication information generation unit 404 is configured to generate authentication information of the historical transaction according to the transaction information of the historical transaction. For example, the authentication information generating unit 404 may execute step S104.

The storage information acquiring unit 406 is configured to acquire storage information of the historical transaction from a block chain. For example, the storage information acquiring unit 406 may perform step S106.

The storage information acquiring unit 406 is configured to acquire a storage address of the storage information of the historical transaction in the block chain according to the transaction information of the historical transaction, and acquire the storage information of the historical transaction according to the storage address of the storage information of the historical transaction in the block chain.

The authorization unit 408 is configured to compare the authentication information of the historical transaction with the storage information of the historical transaction, and determining whether the transaction information of the historical transaction is authentic according to the result of comparison. For example, the authentication unit 408 may perform step S108.

The authentication information of the historical transaction is a hash value generated according to the transaction information of the historical transaction in the authentication request; the storage information of the historical transaction is a hash value generated according to a transaction information obtained when the payment of the historical transaction is successful.

The data processing apparatus 40 may be the source tracing platform or the transaction platform in the foregoing method embodiment.

In some embodiments, the data processing apparatus 40 may further comprise: a transaction information processing unit 410.

The transaction information processing unit 410 is configured to generate storage information of a transaction according to transaction information of the transaction, submit the storage information of the transaction to a block chain cluster, receive a storage address in the block chain of the storage information of the transaction returned by a node in the block chain cluster, and associate the transaction information of the transaction with the storage address of the storage information of the transaction in the block chain and store a relationship between the transaction information of the transaction and the storage address of the storage information of the transaction in the block chain.

In some embodiments, the data processing apparatus 40 may further comprise: a first contract executing unit 412.

The first contract executing unit 412 is configured to: query a storage address of first contract information corresponding to the data information in the block chain, in response to a request for purchasing a right to use data information sent by a purchaser; submit purchase information of the purchaser to a node in a block chain cluster according to the storage address of the first contract information, so that the node in the block chain cluster determines whether the purchaser has a purchasing authority or not according to the purchase information and the first contract information, wherein the first contract information comprises a preset threshold of the number of purchases of the data information or a preset identity attribute of a purchaser; receive an execution result of the first contract sent by the node in the block chain cluster for indicating whether the purchaser has the purchasing authority or not; and return a result of purchasing the right to use the data information to the purchaser according to the execution result of the first contract of the data information.

In some embodiments, the data processing apparatus 40 may further comprise: a second contract executing unit 414.

The second contract executing unit 414 is configured to generate storage information of the data information, in response to a request for selling data information from a seller; submit information of the seller and the generated storage information of the data information to a block chain cluster so that a node in the block chain cluster determines whether the seller has a selling authority of the data information or not according to the information of the seller, the storage information of the data information and second contract information, wherein the second contract information comprises the storage information of the data information stored in the block chain and information of a user having the selling authority which corresponds to the storage information of the data information stored in the block chain; receive an execution result of the second contract returned by the node in the block chain cluster for indicating whether the seller has the selling authority or not; and return a result of selling the data information to the seller according to the second contract execution result of the data information.

In some embodiments, the data processing apparatus 40 may further comprise: a to-be-transacted information processing unit 416.

The to-be-transacted information processing unit 416 is configured to receive, from a source user, data information to be transacted and contract parameters corresponding to the data information to be transacted; generate storage information of the data information to be transacted according to the data information to be transacted; respectively submit to a block chain cluster, the storage information of the data information to be transacted and the contract parameters corresponding to the data information to be transacted; and receive, from a node in the block chain cluster, a storage address in the block chain of the storage information of the data information to be transacted and a storage address in the block chain of contract information generated according to the contract parameters.

It should be noted that the transaction information processing unit 410, the first contract executing unit 412, the second contract executing unit 414, and the to-be-transacted information processing unit 416 in the above embodiments may be arbitrarily added to the data processing apparatus 40 for being combined, or may be arbitrarily combined or used alone as an independent device. For example, the data processing apparatus 40 may comprise only the transaction information processing unit 410, and the first contract executing unit 412.

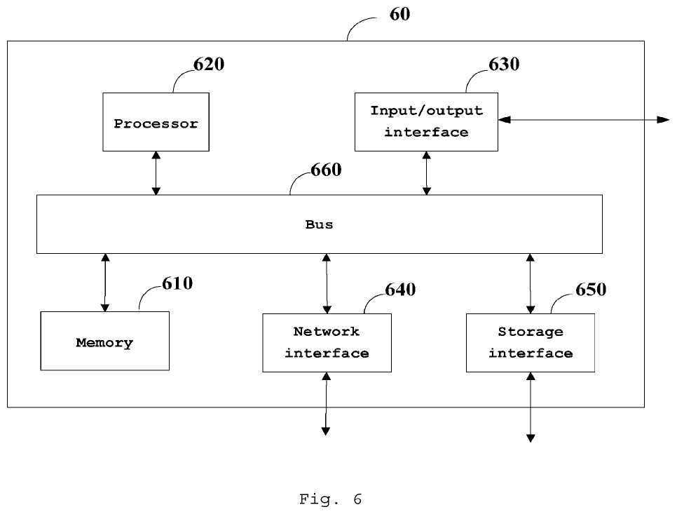

The data processing apparatus in the embodiments of the present disclosure may each be implemented by various computing devices or computer systems, which are described below with reference to FIG. 5 and FIG. 6.

F FIG. 5 is a block diagram of some embodiments of the data processing apparatus of the present disclosure. As shown in FIG. 5, the apparatus 50 of this embodiment comprises: a memory 510 and a processor 520 coupled to the memory 510, wherein the processor 520 is configured to perform the data processing method of any of the embodiments of the present disclosure based on instructions stored in the memory 510.

The memory 510 may comprise, for example, a system memory, a fixed non-volatile storage medium, or the like. The system memory stores, for example, an operating system, an application, a boot loader, a database and other programs, etc.

FIG. 6 is a block diagram of other embodiments of the data processing apparatus in the present disclosure. As shown in FIG. 6, the device 60 in this embodiment comprises a memory 610 and a processor 620, which are respectively similar to the memory 510 and the processor 520, and may also comprise an input/output interface 630, a network interface 640, a storage interface 650, etc. The interfaces 630, 640, 650, the memory 610 and the processor 620 may be connected, for example, via a bus 660. Wherein, the input/output interface 630 provides a connection interface for the input/output devices such as a display, a mouse, a keyboard, a touchscreen, and the like. The network interface 640 provides a connection interface for various networked devices, which may, for example, be connected to a database server or a cloud memory server. The storage interface 650 provides a connection interface for an external storage device such as an SD card or a USB flash disk, etc.

The present disclosure also provides a computer-executable storage medium having stored thereon a computer program which, when executed by a processor, performs the steps of the method of any of the preceding embodiments.

Those skilled in the art will appreciate that embodiments of the present disclosure may be provided as a method, system, or computer program product. Therefore, the embodiments of the present disclosure can take the form of an entirely hardware embodiment, an entirely software embodiment or an embodiment containing both hardware and software elements. Moreover, this disclosure can be in a form of one or more computer program products containing the computer-executable codes which can be implemented in the computer-executable non-transitory storage media (including but not limited to disk memory, CD-ROM, optical memory, etc.).

The present disclosure is described with reference to the flow charts and/or block diagrams of the method, device (system) and computer program product according to the embodiments of the present disclosure. It shall be understood that each flow and/or block in the flowcharts and/or block diagrams and a combination of the flows and/or blocks in the flowcharts and/or block diagrams can be implemented by computer program instructions. These computer program instructions can be provided to a general purpose computer, a special purpose computer, an embedded processor, or a processor of other programmable data processing devices so as to generate a machine for generating means for implementing the functions of one or more flows of a flowchart and/or one or more blocks of a block diagram by using the instructions executed by the computer or the processor of other programmable data processing devices.

These computer program instructions can also be stored in a computer readable memory guiding the computer or other programmable data processing devices to work in a particular way, such that the instructions stored in the computer readable memory generate an article of manufacture containing instruction means which implement the functions of one or more flows of a flowchart and/or one or more blocks in a block diagram.

These computer program instructions can also be loaded onto a computer or other programmable data processing devices such that a series of operational steps are performed on a computer or other programmable devices to produce computer-implemented processing, so that the instructions executed on a computer or other programmable devices provide steps for implementing the functions of one or more flows of a flowchart and/or one or more blocks of a block diagram.

The above content is only preferred embodiments of this present disclosure, but cannot be used for limiting this disclosure. Any modification, equivalent replacement and improvement, etc. within the spirit and principle of this disclosure shall be contained in the scope of protection of this disclosure.

1. A data processing method, comprising:
receiving, from an authenticating user, an authentication request for a historical transaction and transaction information of the historical transaction;
generating authentication information of the historical transaction according to the transaction information of the historical transaction;
acquiring storage information of the historical transaction from a block chain;
comparing the authentication information of the historical transaction with the storage information of the historical transaction, and determining whether the transaction information of the historical transaction is authentic according to the result of comparison.

2. The data processing method according to claim 1, wherein the acquiring storage information of the history transaction from the block chain comprises:
acquiring a storage address of the storage information of the historical transaction in the block chain according to the transaction information of the historical transaction; and
acquiring the storage information of the historical transaction according to the storage address of the storage information of the historical transaction in the block chain.

3. The data processing method according to claim 1, further comprising:
generating storage information of a transaction according to transaction information of the transaction;
submitting the storage information of the transaction to a block chain cluster;
receiving a storage address in the block chain of the storage information of the transaction returned by a node in the block chain cluster; and
associating the transaction information of the transaction with the storage address of the storage information of the transaction in the block chain and storing a relationship between the transaction information of the transaction and the storage address of the storage information of the transaction in the block chain.

4. The data processing method according to claim 1, further comprising:
querying a storage address of first contract information corresponding to the data information in the block chain, in response to a request for purchasing a right to use data information sent by a purchaser;
submitting purchase information of the purchaser to a node in a block chain cluster according to the storage address of the first contract information, so that the node in the block chain cluster determines whether the purchaser has a purchasing authority or not according to the purchase information and the first contract information, wherein the first contract information comprises a preset threshold of the number of purchases of the data information or a preset identity attribute of a purchaser;
receiving an execution result of the first contract sent by the node in the block chain cluster for indicating whether the purchaser has the purchasing authority or not;
returning a result of purchasing the right to use the data information to the purchaser according to the execution result of the first contract of the data information.

5. The data processing method according to claim 1, further comprising:
generating storage information of the data information, in response to a request for selling data information from a seller;
submitting information of the seller and the generated storage information of the data information to a block chain cluster so that a node in the block chain cluster determines whether the seller has a selling authority of the data information or not according to the information of the seller, the storage information of the data information and second contract information, wherein the second contract information comprises the storage information of the data information stored in the block chain and information of a user having the selling authority which corresponds to the storage information of the data information stored in the block chain;
receiving an execution result of the second contract returned by the node in the block chain cluster for indicating whether the seller has the selling authority or not;
returning a result of selling the data information to the seller according to the second contract execution result of the data information.

6. The data processing method according to claim 1, further comprising:
receiving, from a source user, data information to be transacted and contract parameters corresponding to the data information to be transacted;
generating storage information of the data information to be transacted according to the data information to be transacted;
respectively submitting to a block chain cluster, the storage information of the data information to be transacted and the contract parameters corresponding to the data information to be transacted;
receiving, from a node in the block chain cluster, a storage address in the block chain of the storage information of the data information to be transacted and a storage address in the block chain of contract information generated according to the contract parameters.

7. The data processing method according to claim 1, wherein:
the authentication information of the historical transaction is a hash value generated according to the transaction information of the historical transaction in the authentication request;
the storage information of the historical transaction is a hash value generated according to a transaction information obtained when the payment of the historical transaction is successful; and
the transaction information of the historical transaction comprises order information.

8-14. (canceled)

15. A data processing apparatus, comprising:
a processor; and
a memory coupled to the processor and storing instructions that when executed by the processor, cause the processor to
receive, from an authenticating user, an authentication request for a historical transaction and transaction information of the historical transaction;
generate authentication information of the historical transaction according to the transaction information of the historical transaction;
acquire storage information of the historical transaction from a block chain; and
compare the authentication information of the historical transaction with the storage information of the historical transaction, and determine whether the transaction information of the historical transaction is authentic according to the result of comparison.

16. A computer-readable non-transitory storage medium storing computer program instructions, when executed by a processor, cause the processor to:
receive, from an authenticating user, an authentication request for a historical transaction and transaction information of the historical transaction;
generate authentication information of the historical transaction according to the transaction information of the historical transaction;
acquire storage information of the historical transaction from a block chain; and
compare the authentication information of the historical transaction with the storage information of the historical transaction, and determine whether the transaction information of the historical transaction is authentic according to the result of comparison.

17. The computer-readable non-transitory storage medium to claim 16, wherein acquiring storage information of the history transaction from the block chain comprises:
acquiring a storage address of the storage information of the historical transaction in the block chain according to the transaction information of the historical transaction; and
acquiring the storage information of the historical transaction according to the storage address of the storage information of the historical transaction in the block chain.

18. The computer-readable non-transitory storage medium to claim 16, further storing program instructions which, when executed by a processor, cause the processor to:
generate storage information of a transaction according to transaction information of the transaction;
submit the storage information of the transaction to a block chain cluster;
receive a storage address in the block chain of the storage information of the transaction returned by a node in the block chain cluster; and
associate the transaction information of the transaction with the storage address of the storage information of the transaction in the block chain and store a relationship between the transaction information of the transaction and the storage address of the storage information of the transaction in the block chain.

19. The computer-readable non-transitory storage medium to claim 16, further storing program instructions which, when executed by a processor, cause the processor to:
query a storage address of first contract information corresponding to the data information in the block chain, in response to a request for purchasing a right to use data information sent by a purchaser;
submit purchase information of the purchaser to a node in a block chain cluster according to the storage address of the first contract information, so that the node in the block chain cluster determines whether the purchaser has a purchasing authority or not according to the purchase information and the first contract information, wherein the first contract information comprises a preset threshold of the number of purchases of the data information or a preset identity attribute of a purchaser;
receive an execution result of the first contract sent by the node in the block chain cluster for indicating whether the purchaser has the purchasing authority or not; and
return a result of purchasing the right to use the data information to the purchaser according to the execution result of the first contract of the data information.

20. The computer-readable non-transitory storage medium to claim 16, further storing program instructions which, when executed by a processor, cause the processor to:
generate storage information of the data information, in response to a request for selling data information from a seller;
submit information of the seller and the generated storage information of the data information to a block chain cluster so that a node in the block chain cluster determines whether the seller has a selling authority of the data information or not according to the information of the seller, the storage information of the data information and second contract information, wherein the second contract information comprises the storage information of the data information stored in the block chain and information of a user having the selling authority which corresponds to the storage information of the data information stored in the block chain;
receive an execution result of the second contract returned by the node in the block chain cluster for indicating whether the seller has the selling authority or not; and
return a result of selling the data information to the seller according to the second contract execution result of the data information.

21. The computer-readable non-transitory storage medium to claim 16, further storing program instructions which, when executed by a processor, cause the processor to:
receive, from a source user, data information to be transacted and contract parameters corresponding to the data information to be transacted;
generate storage information of the data information to be transacted according to the data information to be transacted;
respectively submit to a block chain cluster, the storage information of the data information to be transacted and the contract parameters corresponding to the data information to be transacted; and
receive, from a node in the block chain cluster, a storage address in the block chain of the storage information of the data information to be transacted and a storage address in the block chain of contract information generated according to the contract parameters.

22. The data processing apparatus according to claim 15, wherein acquiring storage information of the history transaction from the block chain comprises:
acquiring a storage address of the storage information of the historical transaction in the block chain according to the transaction information of the historical transaction; and
acquiring the storage information of the historical transaction according to the storage address of the storage information of the historical transaction in the block chain.

23. The data processing apparatus according to claim 15, wherein the memory further storing instructions which, when executed by a processor, cause the processor to:
generate storage information of a transaction according to transaction information of the transaction;
submit the storage information of the transaction to a block chain cluster;
receive a storage address in the block chain of the storage information of the transaction returned by a node in the block chain cluster; and
associate the transaction information of the transaction with the storage address of the storage information of the transaction in the block chain and store a relationship between the transaction information of the transaction and the storage address of the storage information of the transaction in the block chain.

24. The data processing apparatus according to claim 15, wherein the memory further storing instructions which, when executed by a processor, cause the processor to:
query a storage address of first contract information corresponding to the data information in the block chain, in response to a request for purchasing a right to use data information sent by a purchaser;
submit purchase information of the purchaser to a node in a block chain cluster according to the storage address of the first contract information, so that the node in the block chain cluster determines whether the purchaser has a purchasing authority or not according to the purchase information and the first contract information, wherein the first contract information comprises a preset threshold of the number of purchases of the data information or a preset identity attribute of a purchaser; and
receive an execution result of the first contract sent by the node in the block chain cluster for indicating whether the purchaser has the purchasing authority or not;
return a result of purchasing the right to use the data information to the purchaser according to the execution result of the first contract of the data information.

25. The data processing apparatus according to claim 15, wherein the memory further storing instructions which, when executed by a processor, cause the processor to:
generate storage information of the data information, in response to a request for selling data information from a seller;
submit information of the seller and the generated storage information of the data information to a block chain cluster so that a node in the block chain cluster determines whether the seller has a selling authority of the data information or not according to the information of the seller, the storage information of the data information and second contract information, wherein the second contract information comprises the storage information of the data information stored in the block chain and information of a user having the selling authority which corresponds to the storage information of the data information stored in the block chain;
receive an execution result of the second contract returned by the node in the block chain cluster for indicating whether the seller has the selling authority or not; and
return a result of selling the data information to the seller according to the second contract execution result of the data information.

26. The data processing apparatus according to claim 15, wherein the memory further storing instructions which, when executed by a processor, cause the processor to:
receive, from a source user, data information to be transacted and contract parameters corresponding to the data information to be transacted;
generate storage information of the data information to be transacted according to the data information to be transacted;
respectively submit to a block chain cluster, the storage information of the data information to be transacted and the contract parameters corresponding to the data information to be transacted; and
receive, from a node in the block chain cluster, a storage address in the block chain of the storage information of the data information to be transacted and a storage address in the block chain of contract information generated according to the contract parameters.

27. The data processing apparatus according to claim 15, wherein:
the authentication information of the historical transaction is a hash value generated according to the transaction information of the historical transaction in the authentication request;
the storage information of the historical transaction is a hash value generated according to a transaction information obtained when the payment of the historical transaction is successful; and
the transaction information of the historical transaction comprises: order information.
